(19) United States
(12) Patent Application Publication
(10) Pub. No.: US 2003/0073063 A1
(43) Pub. Date: Apr. 17, 2003

(54) Methods and apparatus for a design, creation, administration, and use of knowledge units

(76) Inventors: Basab Dattaray, Portland, OR (US); Ravindra Kulkarni, Beaverton, OR (US)

Correspondence Address: Daniel R. Pote, Esq., SNELL & WILMER LLP, One Arizona Center, 400 Easten Van Buren, Phoenix, AZ, 85004-2202, US

(21) Appl. No.: 10/167,818

(22) Filed: Jun. 12, 2002

Related U.S. Application Data
(60) Provisional application No. 60/298,304, filed on Jun. 14, 2001.

(51) Int. Cl. G09B 3/00

(52) U.S. Cl. 434/350

(57) ABSTRACT

A distributed learning system includes a server configured to store and deliver knowledge units, wherein said knowledge units comprise interactive content. A user system is configured to selectively connect to said server over a network and to receive and store said knowledge units. The user system includes a browser and a run-time engine configured to interoperate with said Web browser to activate said Knowledge Units. In accordance with another aspect of the present invention, a Knowledge Unit Builder (KUB) is configured to allow authors to create Knowledge Units comprising interactive content.

### CROSS-REFERENCE TO RELATED APPLICATIONS

This application claims priority from U.S. Provisional Patent Application S/No. 60/298,304, filed Jun. 14, 2001.

### BACKGROUND OF THE INVENTION

1. Technical Field

The present invention generally relates to computer-based learning systems. More particularly, the present invention relates to an improved distributed learning system for the design, creation, administration, and use of knowledge units.

2. Background Information

The learning process is highly individualized. As a result, the materials and methods required to address an student's computer-based learning needs (e.g.: the various tests, drag and drop units, and screen simulations) must be similarly individualized.

Prior art training systems are unsatisfactory in a number of respects. For example, on-line, interactive training systems implemented over a distributed network such as the Internet typically require perpetual connection to a database during the training or test-taking session. This connectivity requirement is inconvenient for many students, and is susceptible to network interruptions and other system faults.

Furthermore, such systems require highly-scalable servers to accommodate the large (and often unpredictable) volume of students accessing the system at a given time. In addition, such on-line training sessions typically provide content which is relatively low bandwidth, i.e., simple text based questions/answers and minimal graphics.

While there exist prior art training systems which provide relatively rich content (i.e., high-resolution graphics, video, animation, and the like), such systems do not offer on-line connectivity.

With respect to the production of training content itself, there is a need for flexibility in the mechanisms required to address different learning needs, i.e., the ability to add new training templates and other capabilities without having to make major changes to the core technology. Furthermore, it is desirable to implement a training system which is portable across various software platforms, and which embraces industry standards (e.g.: HTTP, HTML, XML, Java classes, etc.) rather than proprietary interfaces. With respect to security, there is a need for a training system which safeguards against unauthorized copying of content from between desktops.

Thus, there is a need for a system which overcomes these and other limitations of the prior art. For example, there is a need for a secure, flexible, and selectively on-line learning framework which provides for rich interactive content.

### BRIEF SUMMARY OF THE INVENTION

While the way in which the present invention addresses the disadvantages of the prior art will be discussed in greater detail below, in general, the present invention provides a distributed learning system comprising a server configured to store and deliver knowledge units, wherein said knowledge units comprise interactive content. A user system is configured to selectively connect to said server over a network and to receive and store said knowledge units. The user system includes a browser and a run-time engine configured to interoperate with said Web browser to activate said Knowledge Units.

In accordance with another aspect of the present invention, a Knowledge Unit Builder (KUB) is configured to allow authors to create Knowledge Units comprising interactive content.

In accordance with another aspect of the present invention, one or more add-ons can be associated with the Knowledge Unit Builder to simplify the authoring of Knowledge Units.

In accordance with another aspect of the present invention, a Knowledge Unit Publisher (KUP) is configured to allow publishers to specify, inter alia, delivery mechanisms (WWW, CDROM, and the like), payment and licensing schemes, and score tracking methods.

In accordance with yet another aspect of the present invention, a Knowledge Unit Customizer (KUC) is configured to allow instructional designers to build templates which form the basis for the appearance and behavior of the various Knowledge Units.

In accordance with yet another aspect of the present invention, a Knowledge Unit Runtime Engine (KURE) provides the code and/or logic for the various Knowledge Units.

In accordance with yet another aspect of the present invention, a Student Tracking Server is configured to track student progress (e.g., test results, certification level, and the like).

In accordance with yet another aspect of the present invention, an EZGuru License Broker works in conjunction with a Payment Manager and Option Manager to secure the Knowledge Units that run on a user system. In this way, the user (e.g., student) is discouraged from copying and running Knowledge Units on different user systems (or on the same user system) without authorization.

### BRIEF DESCRIPTION OF THE DRAWINGS

The subject invention will hereinafter be described in conjunction with the appended drawing figures, wherein like numerals denote like elements, and:

FIG. 1 is a schematic overview depicting the life-cycle of an exemplary Knowledge Unit;

FIG. 2 depicts an exemplary Knowledge Unit Customizer (KUC) in accordance with another aspect of the present invention;

FIG. 3 depicts an exemplary Knowledge Unit Builder (KUB) in accordance with the present invention;

FIG. 4 depicts an exemplary layout manager add-on in accordance with the present invention;

FIG. 5 is a schematic diagram of an exemplary license management scheme in accordance with the present invention; and

FIG. 6 is a schematic diagram of an exemplary license management process at the user system.

### DETAILED DESCRIPTION

Systems and methods in accordance with the present invention generally provide for a distributed learning system comprising a server configured to store and deliver Knowledge Units (wherein said Knowledge Units comprise interactive content) and a user system configured to selectively connect to said server over a network and to receive and store said knowledge units; said user system including a browser and a run-time engine configured to interoperate with said Web browser to activate said Knowledge Units. In accordance with another aspect of the present invention, a Knowledge Unit Builder (KUB) is configured to allow authors to create Knowledge Units comprising interactive content.

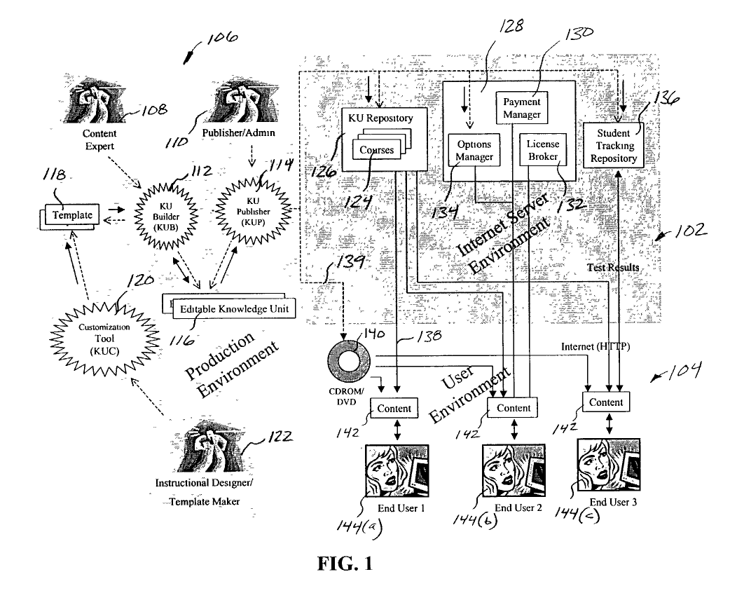

FIG. 1 depicts the life-cycle of one or more Knowledge Units in accordance with the present invention. As shown, the system contemplates interaction between three primary environments: Internet server environment 102, user environment 104, and production environment 106.

As a preliminary matter, the term “Knowledge Unit” refers to a set of components—some interactive, some static—which make up a test, training set, simulation, or any other educational resource. In this regard, a Knowledge Unit might include text, graphics, video, audio, computer code, or any other media in any convenient form, for example, Text, HTML, XML, JPEG, GIF, MPEG, AVI, Java, Javascript, or any other object or class conforming to any protocol now known or developed in the future. The Knowledge Units are preferably “interactive” in the sense that the user (e.g., student) provides input to the Knowledge Unit (through a keyboard, mouse, or any other input means), and the Knowledge Unit is in some way responsive to that input (i.e., by providing graphical and/or textual feedback, indicators of correct or incorrect answers, and the like).

Production environment 106 suitably comprises a content expert 108, a publisher/administrator 110, a KUB 112, a KUP 114, various templates 118, editable Knowledge Units 116, customization tool (KUC) 120, and instructional designer (or template maker) 122. Internet server environment 102 comprises a KU repository 126 (and various courses 124 defined therein), a payment manager 130, a license broker 132, an options manager 134, and a student tracking repository 136. User environment 104 comprises content 142 associated with respective users and user systems 144. User environment 104 also includes various other training media such as CDROMS and/or DVDs 140 as may be required.

User systems 144 suitably comprise any computer, PDA, or other system, either hard-wired or wireless, which can implement the present system. That is, user systems 144 may include any device which a student may wish to use in connection with training, test taking, or the like. While the present invention is described in the context of conventional personal computers, the present invention is not so limited.

Similarly, while the “browser” of the current invention would typically take the form of one of the conventional browsers capable of operating in accordance with the HTTP protocol (e.g., Microsoft Internet Explorer, Netscape, Opera, etc.), the present invention comprehends any client program which serves a similar function.

The solid lines (e.g., 138) in FIG. 1 represent the flow of data, and the dotted lines (e.g., 139) show the calling conventions. For example, there are two lines from KUC 120 to templates 118. The solid line denotes that the data flows from KUC 120 to template 118. The dotted line suggests that the call that results in the data flow (in this embodiment) is initiated from KUC 120.

Instructional designer 122 creates templates using KUC 120, and content expert 108 uses KUB 112 to create the content as editable knowledge units 116. KUB 112 can typically only create Knowledge Units 116 for which templates 118 are available. KUB may also read existing editable knowledge units 116, modify them, and/or store them back as new editable knowledge units 116.

The publisher uses KUP 114 to package an editable knowledge unit 116 into a course 124 that is either placed on the Knowledge Unit Repository 126 and/or in a CDROM/DVD (or other media) 140. KUP 114 may additionally specify the options for the course 124 which ends up in the Options Manager 134. For certification tests, KUP 114 may also specify the student tracking repository 136..

The end users 144 may suitably download content 142 from the Internet (or other network) or simply access the CDROM/DVD 140. By way of example, User Environment Section 104 depicts three different end user scenarios. End User 144(a) simply downloads the content that requires no licenses. She does not take any certification test, so there is no connection with the Student Tracking Database. End User 144(b) is not taking any certification test, but she does need to buy a license to be able to use the content. End User 144(c) is taking a certification test and so she communicates with student tracking repository (136) through the Internet. As described briefly above, the user systems are preferably configured to “selectively connect” to the Internet server. That is, it is desirable for the student to take a test or experience a simulation at least partially off-line. This removes the inconvenience of maintaining an Internet connection to a server over an extended time period. However, it is also desirable for the student to connect to an Internet server and download Knowledge Units and register scores (e.g., in connection with a student tracking repository). Thus, the present invention provides a system for connecting to the Internet server when appropriate (“selectively connecting”) and optionally disconnecting from the Internet server to interact with the Knowledge Unit.

With continued reference to FIG. 1, a functional overview of the various components will now be described. In general, KUB 112 allows authors 108 to produce different kinds of Knowledge Units such as tests, drag-and-drop items, simulations, and the like. KUP 114 suitably allows publishers 114 to determine the appropriate delivery mechanism (Web, CDROM, etc.), payment and licensing scheme, score tracking, etc. KUC 120 allows the instructional designer 122 to build templates 118, wherein templates 118 provide the look and feel of the Knowledge Unit as well as its behavior and logic.

KURE provides the logic and code for the various Knowledge Units. It preferably has its own optimized storage mechanism and meta-scripting engine. Its may be provided as, for example, a CAB or JAR file such that it works well with browsers (e.g., IE5+). KUB 112 and KUC 120 also suitably use the KURE.

The student tracking server (and repository 136) tracks student progress (e.g. test results). The Student Tracking Server may be applicable only for certification tests (e.g., MCSE, Cisco, and the like), in which case student scores are to be recorded. A registered student 144 can start the test only at the time when there is online connectivity. Once started, the student can continue the test in offline mode. In fact, the student 144 may even shut down her PC at the middle of a test and on subsequent power-up be guaranteed to be at the same point in the test before the PC shutdown. However, to submit or abort the test, online connectivity is required. While the student tracking server may be implemented using a directory and file system (for low barrier-to-entry), the interfaces are available to use a standard learning management system as an alternate solution.

License broker 132 is preferably a server-based component that works in conjunction with the payment manager 130 and the option manager 134 to secure the knowledge units that run on the user system. In particular, the security mechanisms discourage the student from either copying and subsequently running the Knowledge Units on a different PC without first acquiring a license (i.e., without authorization), or copying the license file and subsequently reusing it on the same PC to get extended usage.

Knowledge Unit Customizer (KURE)

The KURE preferably provides an optimized storage mechanism with built-in search mechanisms, a meta-scripting engine, and a communication component which, for example, may use a remote scripting language to talk to one or more HTTP servers.

In accordance with one embodiment of the present invention, the KURE has been constructed with the following design objectives:

Small footprint (e.g., about 50 KB in size): Allowing it to be downloaded quickly over low-bandwidth communication channels;

Extensibility: The ability to add extended logic (through Meta-scripting) without requiring the core KURE to be modified;

Portability: Should preferably run on PCs and other devices (such as PDAs, laptops, handheld units, and the like) with minimal source code changes; and

Performance.

Because KURE has a small footprint, it can be used to create stand-alone Knowledge Units that do not require the help of a database for its execution.

The KURE Storage structure in accordance with one embodiment of the present invention is organized in a tree structure that is natural to the organization of Knowledge Units. The basic structure includes a hierarchy of nodes. Each node can have children nodes or sets of attributes. The common attribute types supported include the string, integer, external file or a generic object. Hash tables are appropriately to improve direct access to named nodes.

The KURE meta-scripting engine allows the template developer to quickly develop new templates by taking existing templates and changing the meta-scripts within them. No source code changes to the framework are needed to create new templates so that course developers can incorporate new kinds of Knowledge Units.

The meta-scripts bind the various code fragments and objects (such as HTML code, resource files, Java Scripts, Java classes, XML, and the like) to create web artifacts that portray Knowledge Unit behavior as well as its look and feel. While the present invention is described in the context of meta-scripts to create artifacts related to the learning space, the technology may be used in other domains as well, i.e., web-site development.

In the illustrated embodiment, the meta-scripts are themselves coded as a hierarchy of meta-script nodes. Consequently, the scripts do not have to be parsed separately. The meta-script execution algorithm traverses the meta-script nodes in an in-order fashion with pre and post-computing being done at every node.

The meta-scripting engine provides a number of features, including, for example: the ability to store and/or retrieve data from the Knowledge Units both during design time (when the KUB generates the packaged Knowledge Units) as well at runtime (when the Knowledge Units execute on the user system); the ability to call meta-script methods within the Knowledge Unit as well as in other Knowledge Units; the meta-script methods can be called directly from Java Scripts that run in the browser; the meta-scripts can call out to public methods in external Java Classes, passing along the data-structure representing the Knowledge Unit data; the Meta-Scripts can apply the attribute values to source templates (such as HTML source fragments); the ability to concatenate string values of children meta-script nodes and subsequently assign that to the parent meta-script node; and the ability to defer the execution of certain meta-script nodes till runtime.

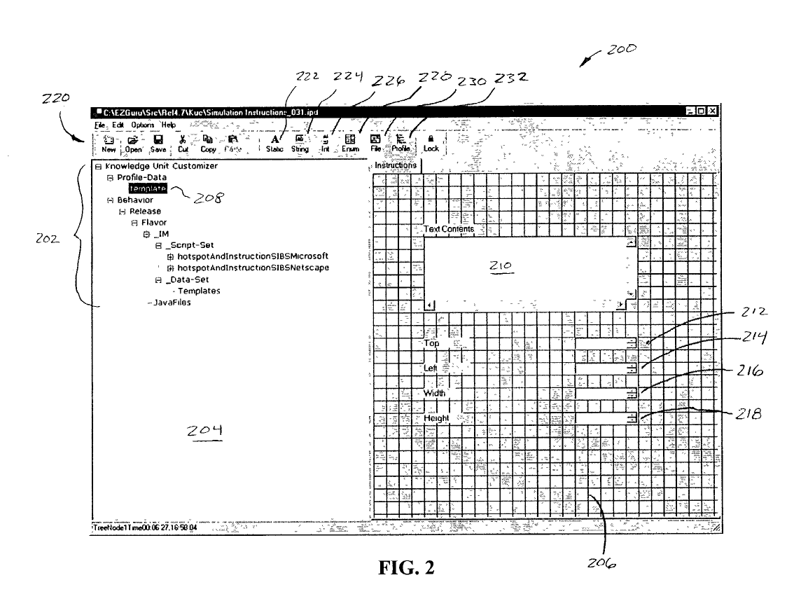

In one embodiment of the present invention, the meta-scripts execute once during Knowledge Unit generation and as many times as required during runtime at the user station. During the first execution, the meta-scripts are preferably pruned by removing all the meta-script nodes (in children-first order) that can be evaluated statically at Knowledge Unit generation time. These pruned scripts are then persisted as a part of the Interactive Knowledge Units. Interactive Knowledge Units (IKU's) are space-optimized to be available as components that execute on the user system. IKU's can not be loaded in the KUB and subsequently edited. The Knowledge Units that can be loaded and edited using the KUB are called Editable Knowledge Units (EKU's). EKU's are typically quite bulky because they have extra information that allows them to be displayed in the KUB and because they are not pruned. FIG. 2 shows an exemplary KUC interface 200. As previously mentioned, the KUC is used by template developers to create new templates and modify existing ones. The template developer uses the KUC to define the structure and behavior of a template in terms of nodes and attributes. The nodes are represented in a hierarchy as a tree 202, as seen on the left hand frame 204. As each node is selected, a set of controls are displayed as groups of attributes on the right hand frame 206. In FIG. 2, for example, the node selected (208) is “template”. The associated attributes are Text Contents 210, Top 212, Left 214, Width 216, and Height 218. These attributes are represented by controls (or widgets). The list of available widgets (shown on the Top Toolbar 220) include Static 222, String 224, Integer 226, Enumeration 228, File 230 and Profile 232. In the above examples, the control representing the “Text Contents” attribute happens to be a Text Widget. The purpose of the widgets is to collect design time information about attributes that include name, default values, etc.

As previously mentioned, the template provides the code that defines the behavior and look and feel of the Knowledge Unit. Different instances of Knowledge Units can carry the same template structure (e.g. a test template) but with different attribute values. While these test instances would have different questions and answer selections, they would all share a common look and feel and behavior.

The tree of templates can be broken up into profile data and a behavior section. The profile-data includes a sub-tree that defines the structural composition in terms of attributes, as well as the definition of interconnectivity among knowledge units. For example, it may define which type of Knowledge Units can be an instance of this template or be a parent of this template.

The behavior section comprises a sub-tree that defines all the meta-scripts for this template in terms of nodes and attributes. These meta-scripts are organized by releases and flavors (allowing the student to pick the presentation from a set of available flavors). The behavior section also allows the template designer to associate the appropriate external helper files required by this template to provide the ultimate runtime experience. Examples of helper files include resources, e.g. bitmaps, sound bites (*.wav), multimedia clips (*.avi, *.mpeg, etc.), objects such as java class files, java scripts, HTML fragments and the like.

The templates that KUC generates can be packaged either in XML format (for readability as well as providing standard interfacing with other tools) or in a proprietary format (for an order of magnitude performance improvement in loading and storing). The KUB that reads the templates can handle either format: XML or proprietary.

Knowledge Unit Builder

Rather than have a host of different builders for different kinds of Knowledge Units (e.g.: tests, drag and drop units and screen simulations), it is advantageous to provide one flexible builder, referred to as the Knowledge Unit Builder (KUB), that can be driven by separate templates. An Instructional Designer with reasonable KUC experience and scripting knowledge would be able to create, for example, a Tic-Tac-Toe template by modifying a copy of the test template. In this way, authors can be rapidly empowered to create different learning materials that meet different needs.

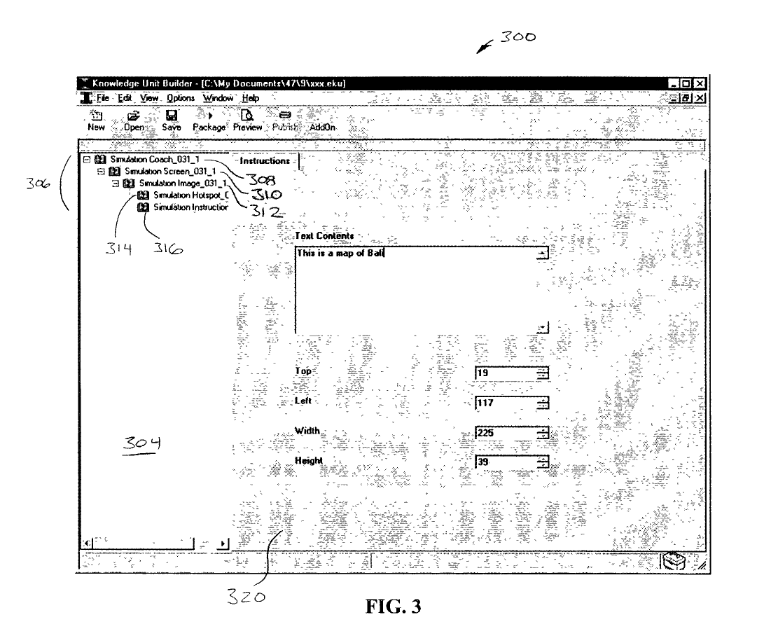

Referring now to FIG. 3, the KUB 300 allows the course developer (author) to create new Editable Knowledge Units (EKU's) or modify existing ones. It also allows the author to generate space and performance optimized Interactive Knowledge Units (IKU's) from the EKU's.

The left-hand frame 304 shows the hierarchy of Editable Knowledge Units (EKU's) 306 that work together to provide the learning experience for the students. The figure shows that the Simulation Coach EKU 308 has a Simulation Screen EKU 310 as its child. The Simulation Screen EKU 310 has a Simulation Image EKU 312 as its child. The Simulation Image EKU 312 in turn has two children EKU's: the Simulation Instruction and Simulation Hotspot EKU (314 and 316, respectively).

FIG. 3 shows that the current focus is on the Simulation Instruction EKU 316. Looking to the right frame 320, we see the same attributes that we encountered when we examined the template for the Simulation Instruction in the KUC (FIG. 2). Through the KUB the author may override the attribute values that were provided as defaults in the corresponding template. While the KUC user can create and modify the script nodes, the KUB user will typically not have access to the meta-Scripts.

KUB Add-ons

While the KUB allows the author to assign values to attributes, it does not always present those attributes in the most convenient form. For example, in specifying the graphical coordinates of a item, the author would typically adjust the graphical attributes in an iterative fashion on a trial-and-error basis. In other words, the author would have to initially guess some attribute values, then generate the IKU's, look at the result, and then adjust the coordinates again and repeat the cycle till the end product looks right.

Accordingly, in accordance with another aspect of the present invention, the KUB allows for separate programs referred to as add-ons that can pop up when the focus is on particular node types that support add-ons. A node type can support zero or more Add-ons. The KUB user has the option of entering attribute values through the regular KUB tab-based interface or invoke any one of the add-on buttons that automatically pop up when the focus is on certain node types.

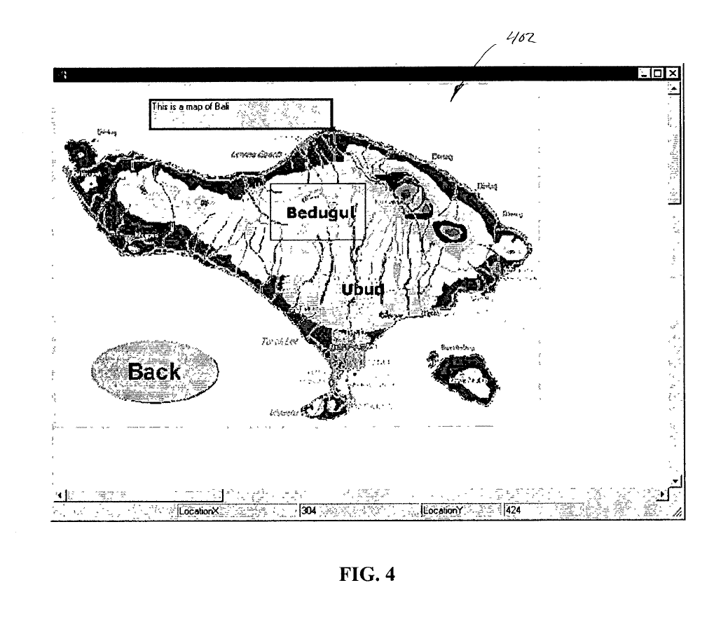

The screen shot shown in FIG. 4 depicts the Simple Layout Manager add-on that was invoked by the KUB user when the KUB focus was on the Simulation Instruction node shown in FIG. 3. In this case, a map 402 is displayed with various buttons. The Simple Layout Manager Add-on shows all the graphical components that are parents or siblings of the node in focus—in this case, the Simulation Instruction node. This particular Add-on also allows the KUB user to resize and change the location of the node in focus. When the Simple Layout Manager Add-on is closed the changed attribute values automatically appear in the standard KUB interface. The values can be changed directly in the KUB if needed.

Different Add-ons can depict different aspects or dimensions. Another example of an Add-on is one that displays timed events related to objects through a timeline scale. New Add-on types can be created by third party vendors who, for example, do not have the KUB source code. To build an add-on, however, the developer would likely have to implement an interface that defines the conditions under which the Add-on is to be popped, includes an in-conversion filter that converts select attributes available in the KUB to the corresponding ones in the add-on, and includes the out-conversion filter that converts add-on attributes to the corresponding KUB attributes.

In cases where the above interface could be implemented for existing specialized off-the-shelf tools, the KUB users will be able to leverage the power of existing specialized tools.

License Management

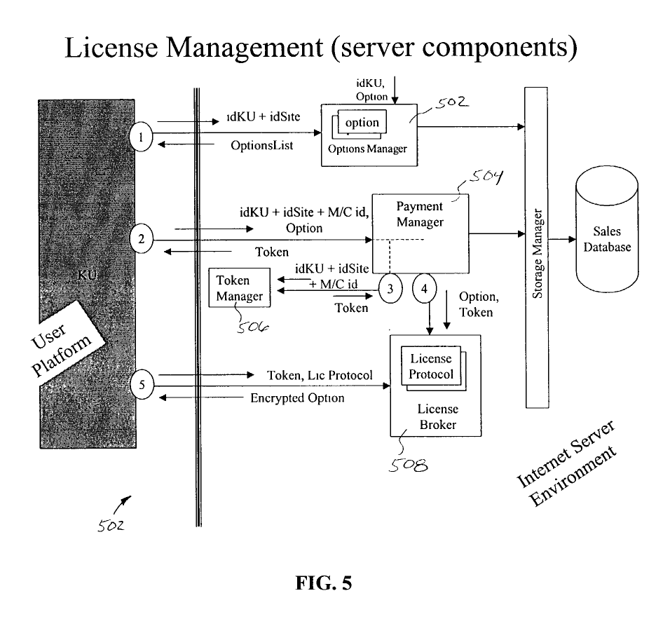

The diagram in FIG. 5 shows an exemplary method wherein the Knowledge Unit on the student desktop (i.e., user system) initiates interactions with various server components, namely, the Option Manager, the Payment Manager and the License Broker, to acquire a license.

In Step 1, the KURE calls Options Manager 502 with the Knowledge Unit Id and receives an offer to pick from a set of available options. Each option is presented with the price as well as duration and/or number of valid invocations, whichever comes first.

In Step 2, the Knowledge Unit user (the student) picks one of the options. The KURE now calls the Payment Manager 504 with the Knowledge Unit Id, the Site Id and the machine Id. The Payment Manager 504 guides the student through the payment process.

In Step 3, the Payment Manager calls the Token Manager 506 to get a unique token for the transaction.

In Step 4, the Payment Manager 504 then sends the Token and the Option to the License Broker 508 and finally sends the token back to the KURE on the student's desktop.

In Step 5, the KURE then sends the EZGuru Name for the License Protocol as well as the Token to the License Broker 508. The License Broker 508 uses the token to find the Option (sent earlier by the Payment Manager). The License Broker 508 also uses the License Protocol name to find the algorithm that also exists in the corresponding KURE. The License manager then encrypts the Option using the algorithm of the found protocol with the token as the seed. The License Broker 508 returns this encrypted Option to the KURE.

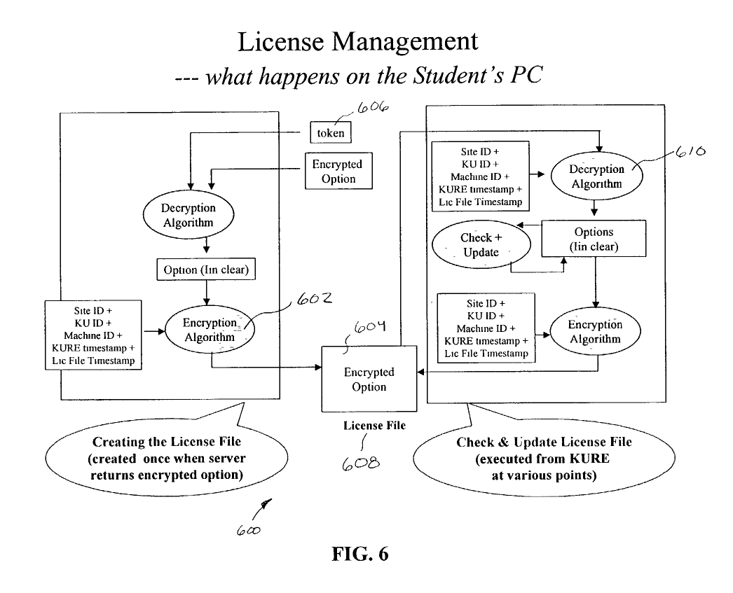

Continuing with this process, FIG. 6 depicts events (600) that occur on the student's desktop after the License Broker has returned the encrypted Option.

In Step 6: KURE applies the Decryption Algorithm 602 on the Encrypted Option 604 with the token 606 as the seed to get the Option in clear text. The Expiry Date is then computed and stored back as the option. It then creates the empty License File 608.

In Step 7, KURE encrypts the Option 604 (with the Expiry Date) using a combination of the Site ID, the Knowledge Unit Id, the Machine ID, the KURE creation date and the License File creation time as the seed. It then stores the encrypted option in the License File 608.

In Step 8 (which is called as many times as the Knowledge Unit is invoked by the user), the Encrypted Option 604 in the License File 608 is decrypted by using the Decryption Algorithm 610 and a seed that uses a combination of the Site ID, the Knowledge Unit Id, the Machine ID, the KURE creation date, and the License File creation time. The Option is checked for validity and if the validation is successful, the option count is decremented. This Option is once again encrypted using the seed that uses a combination of the Site ID, the Knowledge Unit Id, the Machine ID, the KURE creation date and the License File creation time. The Encrypted Option is returned to the License File 608.

It will be appreciated that while the various templates and other components are described in the context of an e-learning domain, ranging from pre-tests, classic tests, tests through tic-tac-toe and Jeopardy games to drag & drop interactions and computer simulations, the method by which learning, training, and testing software programs can be generated automatically, scored flexibly, and accessed via the Internet as well as by disconnected computers, makes their applicability much wider, and more cost effective.

By using the software to automatically develop new templates, it is possible to use the KUB to generate an entire range of Electronic Performance Support Systems. An Electronic Performance Support System (EPSS) is a system that makes dynamic use of software technology to improve individual job and task performance by providing easy and flexible computer access across a wide variety of on-line and off-line computer platforms, to provide timely and easily updated information, advice, coaching testing, flexible scoring, and training, which can be implemented very cost effectively in a wide variety of commercial and academic venues. The software also provides easily-programmed weighted scoring of test questions which can be reprogrammed to reflect the tester's values, and allows partial credits, as well as negative credits for differing answers. This software suite provides maximum flexibility, and ease of reprogramming, from a programming perspective, as well as providing maximum flexibility to the user through access via on-line or off-line computer devices, by both fixed and portable computer devices.

Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention.

What is claimed is:

1. A distributed learning system comprising:
a server configured to store and deliver knowledge units, said knowledge units comprising interactive content;
a user system configured to selectively connect to said server over a network and to receive and store said knowledge units; said user system including a browser and a run-time engine configured to interoperate with said browser to activate said knowledge units.

2. The distributed learning system of claim 1, wherein said server comprises a knowledge unit repository.

3. The distributed learning system of claim 1, wherein said server comprises a student tracking repository.

4. The distributed learning system of claim 1, wherein said server comprises a payment manager, an options manager, or a license broker.

5. The distributed learning system of claim 1, wherein said browser comprises a Web browser conforming to the Hypertext Transfer Protocol (HTTP).

6. The distributed learning system of claim 1, further including a Knowledge Unit Builder configured to create said Knowledge Units via a set of templates.

7. The distributed learning system of claim 1, further including a Knowledge Unit Publisher configured to publish said Knowledge Units to said server.

8. The distributed learning system of claim 1, further including a Knowledge Unit Customization tool.

9. The distributed learning system of claim 6, further including at least one knowledge unit building add-on.

10. The distributed learning system of claim 1, wherein at least one of said Knowledge Units is delivered by a media selected from the group consisting of diskette, CDROM, and DVD.

11. A method of providing knowledge units to a user;
connecting to a server over a network;
receiving, from said server, a knowledge unit stored on said server, said knowledge unit comprising interactive content;
disconnecting from said server;
activating said knowledge unit and generating a result associated with said user's interaction with said knowledge unit;
connecting to said server;
transmitting said result to said server.

12. The method of claim 11, wherein said user selects said knowledge unit from a list of available options provided by said server.

13. The method of claim 11, wherein said user acquires a license to said Knowledge unit.
